(19) United States
(12) Patent Application Publication
(10) Pub. No.: US 2004/0004638 A1
(43) Pub. Date: Jan. 8, 2004

(54) Method and apparatus for multiple-window multiple-selection operations in graphical-user-interface environments

(76) Inventor: Ketan Babaria, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/189,907

(22) Filed: Jul. 2, 2002

(51) Int. Cl. G09G 5/00

(52) U.S. Cl. 345/805; 345/845; 345/769; 345/804

(57) ABSTRACT

A computer system includes a display. The system can be used to perform object operations A cursor is positioned over a source bin image on the display. One or more objects in the source bin image is selected via a cursor control device. A plurality of graphical indicators indicate destination bin images to which the selected objects from the source bin image can be transferred. The selected objects in the source bin image are simultaneously transferred to the destination bin images. Filtering and set operations can be employed in connection with the transfer of the selected objects Visual feedback can be provided to the user regarding the specified operations and completion of transfer of the selected objects. Transfer of the objects can include either a copy or a move operation.

### BACKGROUND OF THE INVENTION

1. Technical Field of the Invention

The present invention relates generally to methods and apparatus for displaying and manipulating information in a computer system, and more specifically to a computer-controlled display apparatus and methods for a user to transfer objects from one or more display windows to one or more other display windows.

2. Description of Related Art

Many computer systems use one of a variety of direct manipulation graphical user interfaces (GUI) in which many previously-coded programming commands are replaced by graphic images or icons on a computer display. These graphic images symbolically represent a variety of objects or operations that are executed by the computer systems when selected A user interacts with the computer system by choosing and manipulating the graphic images

Many GUIs use multiple windows displayed on the computer display in order to convey information to the user The information is typically presented in a combination of text and graphics in the windows. Each window can take the form of a variety of objects, such as, for example a file folder, loose-leaf binder, or a simple rectangle. The windows can overlap one another, with the top window being fully visible and typically constituting a current work file. The user can delete information from a window, move data from one window to another, and generally operate on the window as if an actual physical file were being used. Therefore, the user is permitted to operate on and manipulate the windows' contents and the window itself as if the image constituted an actual object.

Although a variety of GUIs have been developed, the various methods by which a user interfaces with the computer display vary significantly between different computer systems However, many object-oriented GUIs support a drag-and-drop operation for copying or moving objects The user can reorganize her file directory by copying a document into a folder, delete a file by moving a document into a waste basket, or print a file by copying a document onto a printer. In each case, the user selects and moves or copies the document by pressing a button of a mouse while a cursor is located on the document icon, drags the document icon to one of the folder, waste basket, and printer icons by holding down a button on a cursor control device (e.g, a mouse) while repositioning the cursor, and then drops the document icon onto one of the corresponding icons by releasing the button on the cursor control device.

In previously-existing GUI environments, the user can only select one or more objects from one window and move or copy the one or more objects into another single window. There is no provision for a simultaneous multiple drag-and-drop operation from more than one window to a single window or from one window to more than one window. In addition, context-based drag-and-drop operations, such as those employing filtering or set theory operations in connection with the drag-and-drop operations, are not currently available. Instead, existing GUI environments perform one operation at a time, such as, for example, a copy operation or a move operation

It has been found that the functionality of the GUI significantly impacts the efficiency and ease of use of the computer system. Therefore, the ability to perform multiple-window operations or object operations such as those described above in current GUI environments is greatly needed

### SUMMARY OF THE INVENTION

Embodiments in accordance with the invention relate to a method and apparatus for displaying and manipulating information in a computer system. The embodiments allow object manipulation from one or more display windows to one or more display windows An embodiment in accordance with the invention provides a method of performing object manipulation on a computer's display. At least three windows are displayed on the computer display In at least one of the displayed windows is a source bin image The source bin image may contain at least one object. A user may select at least one or more objects in one or more of the source bin image(s). The selected objects are then indicated as being selected A plurality of graphic indicators are provided. The graphic indicator indicates at least one destination bin image to which the selected object(s) can be transferred. In response to a single completion command by the user, the selected object(s) in the source bin image(s) are then transferred to a least two destination bin images.

Another embodiment in accordance with the invention is a computer based apparatus. The computer based apparatus comprises a display that displays at least three windows. At least two of the windows comprise source bin images. At least one of the windows comprise a destination bin image. Each of the source bin images contain at least one object. The computer based apparatus also comprises a cursor adapted to be positioned over a portion of a first source bin image and a second source bin image. The cursor is adapted to be used to select at least one object in the first source bin image and another object in the second source bin image such that selection in the first source bin image yields a first selected object and selection in the second source bin image yields a second selected object. A graphical indicator is provided and adapted to aid selection of a destination bin image(s). Selection of the destination bin image(s) yields a target destination bin image (s). The apparatus is adapted to perform an operation on the first selected object(s) and the second selected object(s) and thereby transfer an operation result to the target destination bin image(s).

Furthermore, the invention provides embodiments with other features and advantages in addition to or in lieu of those discussed above Many of these features and advantages are apparent from the description below with reference to the following drawings.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 illustrates an exemplary computer-based system for generating graphical images in response to user input;

FIGS. 2A-2C illustrate a multiple-window object transfer mode,

FIGS. 3A-3B illustrate a multiple-window object transfer mode with filtering; and

FIG. 4 illustrates a multiple-window object transfer mode.

### DETAILED DESCRIPTION OF THE EXEMPLARY EMBODIMENTS OF THE INVENTION

The numerous innovative teachings of the present application will be described with particular reference to the exemplary embodiments However, it should be understood that this class of embodiments provides only a few examples of the many advantageous uses of the innovative teachings herein. In general, statements made in the specification of the present application do not necessarily delimit any of the various claimed inventions Moreover, some statements may apply to some inventive features but not to others.

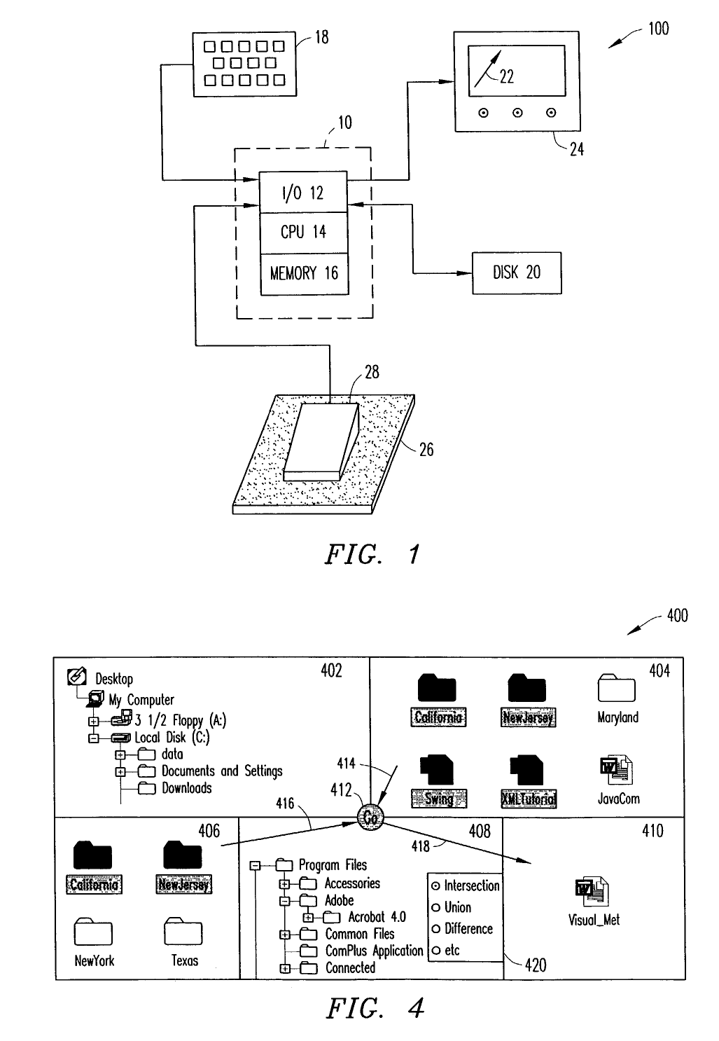

FIG. 1 illustrates an exemplary computer-based system 100 that generates graphical images in response to user input. A computer 10 of the system 100 includes three major components, an input/output (I/O) circuit 12 used to communicate information in appropriately-structured form to and from other portions of the computer 10, a CPU 14 coupled to the I/O circuit 12, and a memory 16 The CPU 14, the I/O circuit 12, and the memory 16 are found in most computers. The computer 10 is intended to be representative of a broad category of computer systems.

One or more data storage devices 20 are coupled to the I/O circuit 12 and provide additional storage capability for the computer 10. The data storage device(s) 20 can include, for example, magnetic disk devices, read/write compact-disk memories, magnetic tape drives, networks coupled to other computer systems, and other reasonable facsimiles or derivations thereof The magnetic disk 20 can store other computer programs, characters, routines, and the like, which can be accessed and executed by the CPU 14.

A display monitor 24 is coupled to the I/O circuit 12 and is used to display images generated by the CPU 14. Any well-known variety of display device can be utilized as the display monitor 24. A data entry device, such as a keyboard 18, is shown coupled to the I/O circuit 12 and is used to input data and commands into the computer 10. A cursor control device 28 is coupled to the computer 10 through the I/O circuit 12. The cursor control device 28 (commonly known as a mouse) permits the user to select various command modes, modify graphic data, and input other data. The cursor control device 28 also permits the user to selectively position a cursor 22 at a desired location on the display monitor 24 by movement of the cursor control device 28 over a surface 26 A variety of cursor control devices, such as, for example, optical mice, mechanical mice, track balls, and joy sticks can be utilized for the cursor control device 28

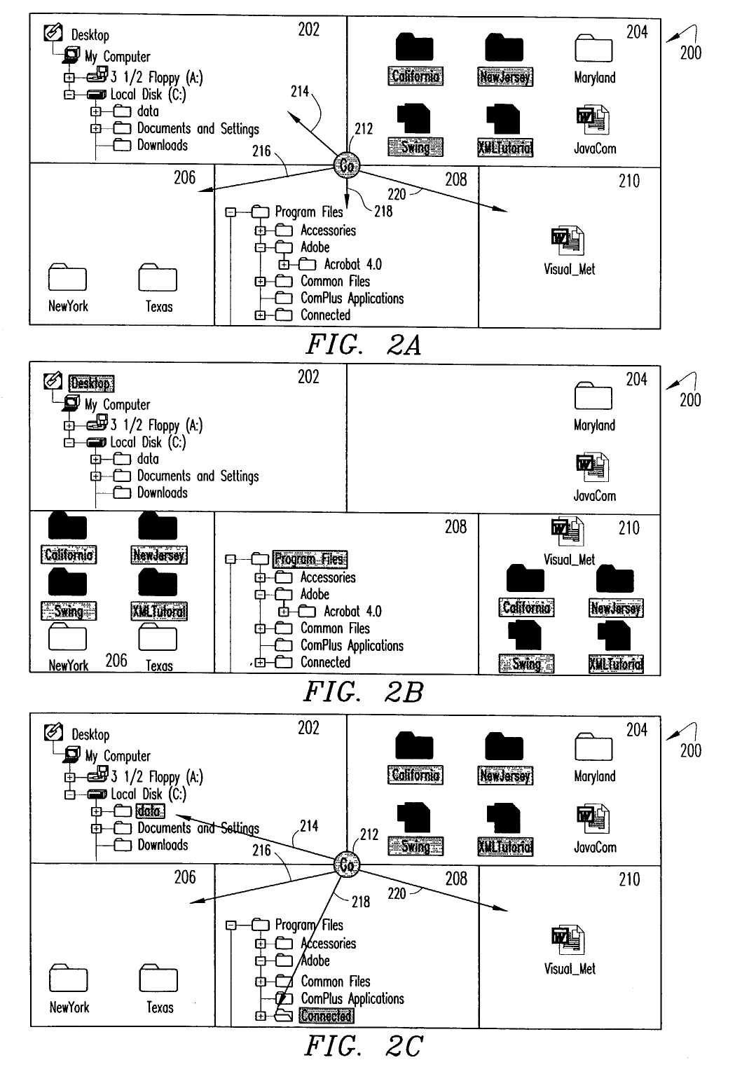

FIGS. 2A-2C illustrate a multiple window object transfer mode in accordance with teachings of the present invention. A display 200, which can be made to appear on the display monitor 24, includes a window 202, a window 204, a window 206, a window 208, and a window 210 Each of the windows 202, 204, 206, 208, and 210 can represent the same or different applications running on, for example, the system 100.

The window 202 and the window 208 as shown each include a file hierarchy as is commonly known in the art. The windows 204, 206, and 210 each include one or more objects, which can be, for example, data files or data folders. In particular, the window 204 includes objects labeled California, NewJersey, Maryland, Swing, XML Tutorial, and JavaCom The objects Swing, XML Tutorial, and JavaCom are illustrated as MICROSOFT WORD files, while the objects California, NewJersey, and Maryland are illustrated as file folders.

The California, NewJersey, Swing and XML Tutorial objects are shown in FIG. 2A as shaded, while the Maryland and JavaCom objects are not shaded The California, NewJersey, Swing, and XML Tutorial objects have been previously shaded using, for example, the cursor control device 28 The window 206 includes objects labeled NewYork and Texas, and the window 210 includes an object labeled Visual_Met. The New York and Texas objects are represented as file folders, while the object Visual_Met is represented as a MICROSOFT WORD file. The objects California, NewJersey, Swing, and XML Tutorial, by virtue of their being shaded, represent a source bin image within the window 204. The graphical indicators 214, 216, 218, and 220 indicate that the windows 202, 206, 208, and 210, respectively, include destination bin images

A transfer button 212 (labeled “Go”) is located at an intersection of the windows 202, 204, and 208 A plurality of graphical indicators 214, 216, 218, and 220, each represented in the form of an arrow, extend from the transfer button 212 The graphical indicator 214 extends from the transfer button 212 to the window 202 The graphical indicator 216 extends from the transfer button 212 to the window 206. The graphical indicator 218 extends from the transfer button 212 to the window 208. The graphical indicator 220 extends from the transfer button 212 to the window 210

Operation of the embodiment of the present invention illustrated in FIGS. 2A-2B will now be described When the user wants to transfer one or more objects to more than one window, the user can select the objects to be transferred. In FIG. 2A, the objects California, NewJersey, Swing and XML Tutorial have been selected, as indicated by their shading The selected objects in the window 204 can be collectively referred to as a source bin image

In a typical embodiment, after the objects California, NewJersey, Swing, and XML Tutorial have been selected by the user, the graphical indicators 214, 216, 218, and 220 are made to appear, as shown in FIG. 2A The graphical indicators 214, 216, 218, and 220 indicate that the objects selected from the window 204 can be transferred to each of the window 202, the window 206, the window 208, and the window 210

In order to transfer the selected objects from the window 204 to the windows 202, 206, 208, and 210, the user selects the transfer button 212 by, for example, positioning the cursor 22 on the transfer button 212 using, for example, the cursor control device 28 and pressing a button on the cursor control device 28. Once the transfer button 212 has been selected by the user, the selected objects from the window 204 are transferred to predefined default locations in each of the windows 202, 206, 208, and 210. Thus, in response to a single completion command by the user (e.g, the user selecting the transfer button 212), the selected objects from the window 204 are transferred to the predefined default locations in each of the windows 202, 206, 208, and 210

In a typical embodiment, upon completion of the transfer of the selected objects from the window 204, feedback is provided to the user to indicate that the transfer of the selected objects from the window 204 has been completed. For example, color, length, or other appearance of the graphical indicators 214, 216, 218, and 220 can change and the graphical indicators 214, 216, 218, and 220 can disappear upon completion of the transfer of the objects selected from the window 204 to the windows 202, 206, 208, and 210. FIG. 2B illustrates that, in a typical embodiment, upon completion of the transfer of the selected objects from the window 204, the graphical indicators 214, 216, 218, and 220, as well as the transfer button 212, have disappeared.

Upon completion of the selected-object transfers from the window 204, the selected objects from the window 204 are shown in FIG. 2B to be located in, for example, a Desktop portion of the window 202 (wherein the Desktop portion is the default location for the window 202), in the window 206 (wherein the window 206 itself is a default location), in a Program Files portion of the window 208 (wherein the Program Files portion is the default location of the window 208), and in the window 210 (wherein the window 210 itself is a default location)

In the example shown in FIGS. 2A-2B, the selected objects from the window 204 are no longer located in the window 204 after having been transferred from the window 204 The operation thus illustrated is typically referred to as a move operation, but may be better described in this embodiment as a multiple-move operation The principles illustrated in FIGS. 2A-2B are equally applicable to an operation in which the selected objects from the window 204 are transferred to the windows 202, 206, 208, and 210 and still remain in the window 204, which operation is commonly referred to as a copy operation, but may be better described in this operation as a multiple-copy operation

In FIG. 2C, the objects labeled California, New Jersey, Swing, and XML Tutorial of the window 204 have been selected as in FIG. 2A However, in contrast to FIG. 2A, in FIG. 2C, the graphical indicators 214, 216, and 218 have each been rotated and adjusted in length from what is shown on FIG. 2A in order to indicate a transfer of the selected objects in the window 204 to a particular target location or object in each of the windows 204, 206, 208, and 210.

In particular, the graphical indicator 214 has been rotated and stretched to extend to an object represented as a subfolder in the window 202 labeled data. The data subfolder has been selected as a particular target object to which the selected objects in the window 204 are to be transferred, as shown by shading of the icon in the window 202 representing the data subfolder In a similar fashion, the graphical indicator 216 has been rotated and adjusted in length to point to a portion of the window 206 other than the NewYork and Texas folders shown therein, however, because the graphical indicator 216 is not pointing to the object NewYork or the object Texas and therefore neither the object NewYork nor the object Texas is shaded, the selected objects from the window 204 will be copied into the default location of the window 206.

In a similar fashion, the graphical indicator 218 has been rotated and adjusted in length in order to transfer the selected objects from the window 204 to an object represented as a subfolder in the window 208 labeled Connected. The graphical indicator 220 has not been rotated or adjusted in length from that shown in FIG. 2A; therefore, the selected objects from the window 204 will be transferred to the default location of the window 210 as in FIG. 2A Rotation and length adjustment of the graphical indicators 214, 216, 218, and 220 can be effected via the cursor control device 28.

Use of the graphical indicators 214, 216, 218, and 220 provides the user with better feedback than has been available in prior art systems by letting the user point the graphical indicators to a particular target object to which the selected objects from the window 204 are to be transferred When the user selects the objects in the window 204, the transfer button 212 and the graphical indicators 214, 216, 218, and 220 typically appear, as shown in FIG. 2C. Thereafter, the user can adjust the length and direction of the graphical indications 214, 216, 218, and 220 to point to a particular target object to which the selected objects are to be transferred The step of pointing the graphical indicators to a particular target object and the step of selecting the objects to be transferred can be performed in either order.

When the user selects the transfer button 212 shown in FIG. 2C, the objects selected from the window 204 are transferred to the particular target objects as indicated by the graphical indicators 214, 216, 218, and 220. After the selected objects from the window 204 have been transferred, the transfer button 212 and the graphical indicators 214, 216, 218, and 220 can operate in a similar fashion to that described above with respect to FIG. 2B

Although FIGS. 2A-2C illustrate multiple-move operations, it will be apparent to those skilled in the art that the principles illustrated therein are equally applicable to a multiple-copy operation as well In a typical embodiment, the graphical indicators 214, 216, 218, and 220 can be made to appear different depending upon whether the user is performing a multiple-move operation or a multiple-copy operation, so that the user has different visual feedback depending on which operation is to be performed

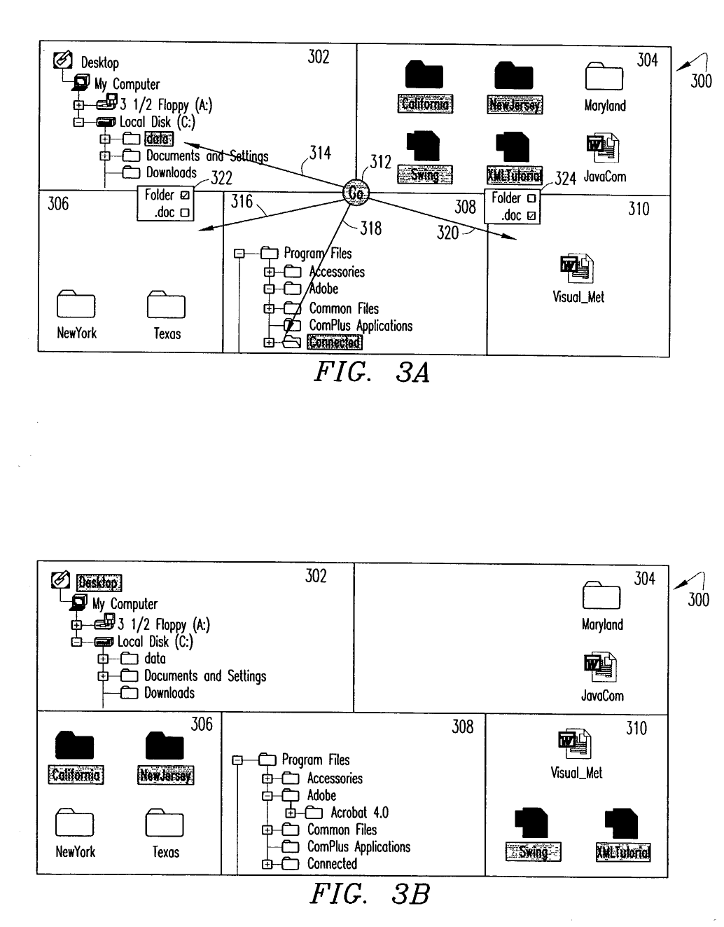

FIGS. 3A-3B illustrate a multiple-window object transfer mode that filters data in accordance with teachings of the present invention. A display 300, which can be made to appear on the display monitor 24, includes a window 302, a window 304, a window 306, a window 308, and a window 310 Each of the windows 302, 304, 306, 308, and 310 can represent the same or different applications running on, for example, the system 100.

The window 302 and the window 308 as shown each include a file hierarchy as is commonly known in the art. The windows 304, 306, and 310 each include one or more objects, which can be, for example, data files or data folders. In particular, the window 304 includes objects labeled California, NewJersey, Maryland, Swing, XML Tutorial, and JavaCom. The objects Swing, XML Tutorial, and JavaCom are illustrated as MICROSOFT WORD files, while the objects California, NewJersey, and Maryland are illustrated as file folders.

The California, NewJersey, Swing and XML Tutorial objects are shown in FIG. 3A as being shaded, while the Maryland and JavaCom objects are not shaded The California, NewJersey, Swing, and XML Tutorial objects have been previously shaded via, for example, the cursor control device 28. The window 306 includes objects labeled NewYork and Texas and the window 310 includes an object labeled Visual_Met. The NewYork and Texas objects are represented as file folders, while the object Visual_Met is represented as a MICROSOFT WORD file. The objects California, NewJersey, Swing, and XML Tutorial, by virtue of their being shaded, represent a source bin image within the window 304. The graphical indicators 314, 316, 318, and 320 indicate that the windows 302, 306, 308, and 310, respectively, include destination bin images

A transfer button 312 (labeled “Go”) is located at an intersection of the windows 302, 304, and 308 A plurality of graphical indicators 314, 316, 318, and 320, each represented in the form of an arrow, extend from the transfer button 312. The graphical indicator 314 extends from the transfer button 312 to the window 302. The graphical indicator 316 extends from the transfer button 312 to the window 306. The graphical indicator 318 extends from the transfer button 312 to the window 308 The graphical indicator 320 extends from the transfer button 312 to the window 310.

Operation of the embodiment of the present invention illustrated in FIGS. 3A-3B will now be described. When the user wants to simultaneously transfer one or more objects from a source bin image to more than one window including a destination bin image and also wants the transfer of the objects to include a filtering operation, the user can select the objects to be transferred and also specify a filtering operation to be applied relative to the selected objects from the source bin image. The filtering operation can be based on a file name extension, on the file size, or other pre-defined criteria. In a typical embodiment, specifying the filtering operation includes choosing filtering criteria relative to one or more of the destination bin images, so that the chosen filtering criteria will be applied in connection with transferring of the selected objects to the one or more destination bin images

After the objects California, NewJersey, Swing, and XML Tutorial have been selected by the user, the graphical indicators 314, 316, 318, and 320 appear, as shown in FIG. 3A. The graphical indicators 314, 316, 318, and 320 indicate that the objects selected from the window 304 can be transferred to each of the window 302, the window 306, the window 308, and the window 310

FIG. 3A also illustrates filter boxes 322 and 324. The filter box 322 is associated with the window 306 and the graphical indicator 316, while the filter box 324 is associated with the window 310 and the graphical indicator 320. Each of the filter boxes 322 and 324 typically appears at substantially the same time as the transfer button 312 and the graphical indicators 314, 316, 318, and 320.

The filter box 322 and the filter box 324 each include a Folders label and a doc label. The Folders and .doc labels have associated therewith portions of the filter boxes 322 and 324 that are adapted to allow the user to select folders or .doc (i.e., MICROSOFT WORD) objects from the window 304 that are to be transferred to the window 306 and the window 310, respectively. For example, because the selected objects include folders and MICROSOFT WORD objects, the two choices given in each of the filter boxes 322 and 324 designate these two types of objects.

The filter box 322 has the Folders label checked, while the filter box 324 has the doc label checked By checking the Folders label in the filter box 322, the user has indicated that only folder objects selected from the window 304 are to be transferred to the window 306 By selecting the .doc label of the filter box 324, the user has indicated that only MICROSOFT WORD objects selected from the window 304 are to be transferred to the window 310

In order to transfer the selected objects from the window 304 to the windows 302, 306, 308, and 310, the user selects the transfer button 312 by, for example, positioning the cursor 22 on the transfer button 312 via the cursor control device 28 and pressing a button on the cursor control device 28. Once the transfer button 312 has been selected by the user, the selected objects from the window 304 are transferred to selected locations in each of the windows 302, 306, 308, and 310 in accordance with the filtering criteria selected by the user via the filter boxes 322 and 324.

In FIG. 3A, in a similar fashion to FIG. 2C, the graphical indicators 314, 316, and 318 can be rotated and adjusted in length in order to indicate a transfer of the selected objects in the window 304 to a particular target location or object in each of the windows 304, 306, 308, and 310. In particular, the graphical indicator 314 has been rotated and stretched to extend to an object represented as a subfolder in the window 302 labeled data. The data subfolder has been selected as a particular target object to which the selected objects in the window 304 are to be transferred, as shown by shading of the icon in the window 302 representing the data subfolder In a similar fashion, the graphical indicator 316 has been rotated and adjusted in length to point to a portion of the window 306 other than the NewYork and Texas folders shown therein, however, because the graphical indicator 316 is not pointing to the object NewYork or the object Texas and therefore neither the object NewYork nor the object Texas is shaded, the selected objects from the window 304 will be transferred to the default location shown in FIG. 3A of the window 306

In a similar fashion, the graphical indicator 318 has been rotated and adjusted in length in order to transfer the selected objects from the window 304 to an object represented as a subfolder in the window 308 labeled Connected. The graphical indicator 320 has not been rotated or adjusted in length; therefore, the selected objects from the window 304 will be transferred to the default location of the window 310 Rotation and length adjustment of the graphical indicators 314, 316, 318, and 320 can be effected by use of the cursor control device 28.

In a typical embodiment, upon completion of the transfer of the selected objects from the window 304, feedback is provided to the user to indicate that the transfer of the selected objects from the window 304 has been completed. For example, color, length, or other appearance of the graphical indicators 314, 316, 318, and 320 can change and the graphical indicators 314, 316, 318, and 320 can disappear upon completion of the transfer of the objects selected from the window 304 to the windows 302, 306, 308, and 310.

Upon completion of the transfer of the selected objects from the window 304, the selected objects from the window 304 are shown in FIG. 3B to be located in the data subfolder of the window 302, in the window 306, in the Connected subfolder of the window 308, and in the window 310 In the example shown in FIGS. 3A-3B, the selected objects from the window 304 are no longer located in the window 304 after having been transferred from the window 304. The operation thus illustrated is typically referred to as a move operation. The principles illustrated in FIGS. 3A-3B are equally applicable to an operation in which the selected objects from the window 304 are transferred to the windows 302, 306, 308, and 310 and still remain in the window 304, which operation is commonly referred to as a copy operation. In a typical embodiment, the graphical indicators 314, 316, 318, and 320 can be made to appear different depending upon whether the user is performing a move operation or a copy operation, so that the user has visual feedback regarding which operation is to be performed

Use of the graphical indicators 314, 316, 318, and 320 provides the user with better feedback than has been available in prior art systems by letting the user point the graphical indicators to a particular target object to which the selected objects from the window 304 are to be transferred. When the user selects the objects in the window 304, the transfer button 312 and the graphical indicators 314, 316, 318, and 320 appear, as shown in FIG. 3A Thereafter, the user can adjust the length and direction of the graphical indications 314, 316, 318, and 320 to point to any particular target object to which the selected objects are to be transferred and select filtering criteria via the filter boxes 322 and 324 The step of pointing the graphical indicators to a particular target object, the step of selecting the objects to be transferred, and the step of specifying the filtering criteria can be performed in any order.

FIG. 3B illustrates that, upon completion of the transfer operation initiated by the user selecting the transfer button 312, the objects California and NewJersey have been transferred to the selected portion of the window 306 and the objects Swing and XML Tutorial have been transferred to the selected portion of the window 310 in accordance with the filtering criteria specified by the user via the filter boxes 322 and 324. The objects California, NewJersey, Swing, and XML Tutorial have been transferred to the data subfolder of the window 302 and to the Connected subfolder of the window 308. All of the selected objects from the window 304 have been transferred to the data subfolder of the window 302 and to the Connected subfolder of the window 308, since no filter box was used relative to the graphical indicator 314 and the window 302 or the graphical indicator 318 and the window 308.

While FIGS. 3A-B illustrate a plurality of graphical indicators 314, 316, 318, and 320, a single graphical indicator can be utilized in accordance with principles of the present invention As with the graphical indicators 314, 316, 318, and 320, the single graphical indicator can be rotated and stretched to indicate a particular target location or object within a destination bin image of a window to which selected objects are to be transferred. The single graphical indicator can also be employed with a filter box, such as, for example, the filter box 322. Depending upon design criteria, a transfer button similar to the transfer button 312 can be used in connection with the single graphical indicator, or, in the alternative, the cursor control device 28 can be used to allow the user to point the single graphical indicator to the particular target object and then release a button on the cursor control device 28 in order to initiate transfer of the selected objects to the particular target object.

In addition, although each of the graphical indicators 314, 316, 318, and 320 is shown pointing to a different window of the display 300, a plurality of graphical indicators can be stretched and rotated in accordance with principles of the present invention to different target objects within the same window. Moreover, a filter box can be applied to one or more of the plurality of graphical indicators to allow a filtering operation to be applied to some of the target objects within the same window and not to others

FIG. 4 illustrates a multiple window object transfer mode in accordance with teachings of the present invention. A display 400, which can be made to appear on the display monitor 24, includes a window 402, a window 404, a window 406, a window 408, and a window 410. Each of the windows 402, 404, 406, 408, and 410 can represent the same or different applications running on, for example, the system 100

The window 402 and the window 408 as shown each include a file hierarchy as is commonly known in the art The windows 404, 406, and 410 each include one or more objects, which can be, for example, data files or data folders In particular, the window 404 includes objects labeled California, NewJersey, Maryland, Swing, XML Tutorial, and JavaCom. The window 406 also includes the California and NewJersey objects. The objects Swing, XML Tutorial, and JavaCom are illustrated as MICROSOFT WORD files, while the objects California, NewJersey, and Maryland are illustrated as file folders.

The California, NewJersey, Swing, and XML Tutorial objects are shown in FIG. 4 as being shaded, while the Maryland and JavaCom objects are not shaded. The California, NewJersey, Swing, and XML Tutorial objects have been previously shaded via, for example, the cursor control device 28. The window 406 includes objects labeled NewYork and Texas in addition to the California and NewJersey objects, and the window 410 includes an object labeled Visual_Met. The NewYork and Texas objects are represented as file folders, while the object Visual_Met is represented as a MICROSOFT WORD file.

A transfer button 412 (labeled “Go”) is located at an intersection of the windows 402, 404, and 408 A plurality of graphical indicators 414, 416, and 418, each represented in the form of an arrow, connect with the transfer button 412. The graphical indicator 414 extends to the transfer button 412 from the window 402. The graphical indicator 416 extends to the transfer button 412 from the window 406. The graphical indicator 418 extends from the transfer button 412 to the window 410.

The objects California, NewJersey, Swing, and XML Tutorial, by virtue of their being shaded, represent a source bin image within each of the windows 404 and 406. The graphical indicator 418 indicates that the window 410 includes destination bin images, while the graphical indicators 414 and 416 indicate that the windows 404 and 406 include source bin images

An operation box 420 is shown in connection with the graphical indicator 418 and the window 410 The operation box 420 includes the following labels: Intersection, Union, and Difference. The operation box 420 typically appears when the graphical indicators 414, 416, and 418 and the transfer button 412 appear in response to the user selecting one or more objects to be transferred The operation box 420 allows the user to specify which of a plurality of set operations is to be performed on the selected objects from the windows 404 and 406.

For example, the Intersection label is selected in the box 420 When the user selects the transfer button 412, the object California and the object NewJersey are transferred to the window 410 In a similar fashion, if the Union label of the operation box 420 were chosen by the user, upon the user selecting the transfer button 412, the California, NewJersey, Swing, and XML Tutorial objects would be transferred to the window 410. Although the Intersection and Union labels have been illustrated in the box 420, other operations can be specified in the operation box 420 without departing from the principles of the present invention. After the operation chosen in the operation box 420 has been performed on the selected objects, in a typical embodiment, the transfer button 412 and the graphical indicators 414, 416, and 418 disappear The embodiment of the present invention illustrated in FIG. 4 can be readily applied to either a move operation or a copy operation. Moreover, an operation box can be applied to one or more of a plurality of graphical indicators to allow a particular set operation to be applied to some graphical indicators and not to others Further, the graphical indicators can be made to have a different appearance to indicate whether they are used, for example, a copy operation or a move operation. Filter boxes and operation boxes can also be combined in numerous different embodiments

As will be recognized by those having skill in the art, the innovative concepts described in this patent application can be modified and varied over a wide range of applications In particular, the various embodiments of the present invention can be combined in various ways without departing from the principles of the present invention. The scope of patented subject matter should accordingly not be limited to any of the specific exemplary teachings discussed herein, but is instead defined by the following claims

What is claimed is:

1. A method of performing object manipulation on a computer display, the method comprising:
displaying at least three windows on the display, at least one of the windows comprising a source bin image and at least two of the windows comprising a destination bin image, the source bin image containing at least one object;
responding to selection of at least one object in the source bin image, thereby yielding at least one selected object in the source bin image;
providing a plurality of graphical indicators, each of the plurality of graphical indicators indicating a different destination bin image to which the at least one selected object in the source bin image can be transferred, and
transferring, in response to a single completion command by the user, the at least one selected object in the source bin image to at least two destination bin images to which the at least one selected object in the source bin image can be transferred

2 The method of claim 1, wherein the step of transferring further comprises deleting the at least one selected object from the source bin image, thereby yielding a multiple-move operation

3 The method of claim 1, wherein the step of transferring further comprises leaving the at least one selected object in the source bin image, thereby yielding a multiple-copy operation

4 The method of claim 1, further comprising, before the step of transferring.
responding to selection, via at least one of the plurality of graphical indicators, of an object within at least one of the at least two destination bin images, the selection designating to which object within the at least one of the at least two destination bin images the at least one selected object in the source bin image is to be transferred; and
providing feedback to the user indicating that the selected object within the at least one of the at least two destination bin images has been selected

5 The method of claim 1, further comprising specifying a filtering operation to be applied relative to the at least one selected object in the source bin image.

6. A computer-based apparatus comprising:
a display displaying at least three windows, at least two of the windows comprising source bin images and at least one of the windows comprising a destination bin image, the source bin images each containing at least one object;
a cursor adapted to be positioned over at least a portion of a first source bin image and a second source bin image and adapted to be used to select at least one object in the first source bin image and the second source bin image, selection of the first source bin image yielding at least one first selected object and selection of the second source bin image yielding at least one second selected object,
a graphical indicator adapted to select a destination bin image, selection of the destination bin image yielding a target destination bin image; and
wherein the apparatus is adapted to perform an operation on the at least one first selected object, and the at least one second selected object and to transfer a result of the operation to the target destination bin image

7 The apparatus of claim 6, wherein the result of the operation comprises an intersection.

8. The apparatus of claim 6, wherein the result of the operation comprises a union

9 The apparatus of claim 6, wherein the result of the operation comprises a difference

10 The apparatus of claim 6, wherein the apparatus is adapted to perform a filtering operation in connection with the transfer of the operational result to the target destination bin image

11. The apparatus of claim 6, wherein the apparatus is adapted to provide feedback to the user indicating that the target destination bin image has been selected.

12 An article of manufacture for performing object operations, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
generate and display at least three windows on a display, at least two of the windows comprising source bin images and at least one of the windows comprising a destination bin image, the source bin images each containing at least one object,
permit selection, via a cursor control device, of at least one object in the first source bin image, the selection of the at least one object in the first source bin image yielding at least one first selected object,
permit selection, via the cursor control device, of at least one object in the second source bin image, the selection of the at least one object in the second source bin image yielding at least one second selected object,
permit positioning of a graphical indicator on a destination bin image, the positioning yielding a target destination bin image;
perform an operation on the at least one first selected object and the at least one second selected object, thereby yielding an operational result, and
transfer the operational result to the target destination bin image

13 The article of claim 12, wherein the operational result comprises an intersection.

14 The article of claim 12, wherein the operational result comprises a union.

15. The article of claim 12, wherein the operational result comprises a difference

16. The article of claim 12, wherein the processor instructions are configured to be readable from the at least one computer readable medium by the at least one processor and thereby cause the at least one processor to operate as to permit specification of a filtering operation to be applied in connection with the step of transferring the operational result to the target destination bin image

17. The article of claim 12, wherein the processor instructions are configured to be readable from the at least one computer readable medium by the at least one processor and thereby cause the at least one processor to operate as to provide feedback to the user indicating that the target destination bin image has been selected.

18 A computer-based apparatus comprising:
at least three windows on a display, at least one of the windows comprising a source bin image and at least two of the windows comprising a destination bin image, the source bin image containing at least one object;
a cursor adapted to be used to select at least one object in the source bin image, selection of the at least one object yielding at least one selected object in the source bin image; and
a plurality of graphical indicators, each of the plurality of graphical indicators being adapted to indicate a destination bin image to which the at least one selected object in the source bin image can be transferred, wherein the at least one selected object in the source bin image can be simultaneously transferred to at least two destination bin images indicated by the plurality of graphical indicators.

19. The apparatus of claim 18, wherein upon transfer of the at least one selected object, the at least one selected object is deleted from the source bin image

20 The apparatus of claim 18, wherein upon transfer of the at least one selected object, the at least one selected object is left in the source bin image.

21. The apparatus of claim 18, wherein at least one of the plurality of graphical indicators is adapted to be used to select an object within at least one of the at least two destination bin images, selection of the object within at least one of the at least two destination bin images designating to which object within the at least one of the at least two destination bin images the at least one selected object in the source bin image is to be transferred, and wherein the apparatus is adapted to provide feedback to the user indicating that the object within the at least one of the at least two destination bin images selected has been selected.

22 The apparatus of claim 18, wherein the apparatus is adapted to permit the user to specify a filtering operation to be applied relative to the at least one selected object in the source bin image.
